(19) United States
(12) Patent Application Publication
(10) Pub. No.: US 2023/0352899 A1
(43) Pub. Date: Nov. 2, 2023

(54) System and Method for Gradient Interferometrically Locked Laser Source

(71) Applicant: Nutronics, Inc., Vancouver, WA (US)

(72) Inventors: Jeffrey D. Barchers, Longmont, CO (US); Dale H. Martz, Lafayette, CO (US)

(21) Appl. No.: 18/310,475

(22) Filed: May 1, 2023

Related U.S. Application Data
(60) Provisional application No. 63/336,915, filed on Apr. 29, 2022.

(51) Int. Cl. H01S 3/10; G02B 27/30; G01J 9/02; G02B 27/12; H01S 3/23; G02F 2/00

(52) U.S. Cl. CPC H01S 3/10053; G01J 9/02; G02B 27/123; G02B 27/30; G02F 2/00; H01S 3/2308; G01J 2009/0203; G01J 2009/0211

(57) ABSTRACT

Systems and methods for forming a coherent optical phased array laser source from a spatially combined array of output beams is accomplished without any external measurement devices or wavefront sensors. A master oscillator laser is split into a plurality of optical beam transport and amplifier channels to produce a plurality of optical output beams that are spatially combined in an array format. The spatial phase state of the plurality of output beams is measured at the output of a spatial combiner without use of an external measurement device or sensor. The phase of the plurality of optical output beams is controlled to compensate both for aberrations induced by the optical beam transport and amplifier paths to produce a coherent and spatially phased laser beam at the output of the laser source or to produce a phased laser beam with prescribed phase state on each output beam.

### CROSS-REFERENCE TO RELATED APPLICATIONS

This application claims the benefit under 35 U.S.C. § 119(e) of U.S. Provisional Patent Application No. 63/336,915, filed Apr. 29, 2022, entitled “SYSTEM AND METHOD FOR GRADIENT INTERFEROMETRICALLY LOCKED LASER SOURCE”, the contents of which are incorporated herein by reference in their entirety.

### FIELD OF INVENTION

The present disclosure relates to a method and several system implementations for producing a coherent optical phased array laser source from a spatially combined array of output beams to form a coherent optical beam.

### BACKGROUND OF THE INVENTION

Formation of a coherent laser beam has multiple approaches. A particular method for formation of a coherent high energy laser beam or HEL is to utilize an optical phased array comprised of a master oscillator laser, an optical beam splitter that splits the output of the master oscillator laser into a plurality of optical channels, a phase modulation device in a low power beam path of said plurality of optical channels which is followed by a plurality of amplifiers to form a high power composite beam. The output of the plurality of the optical channels is typically arranged in a linear or hexagonal fashion and variations may exist that maximize the fill factor of the beam output. This method is typically referred to as an optical phased array laser. When the beam transport between the elements described above is single mode optical fiber, then this method can be referred to as a fiber optical phased laser array. However, prior methods of forming an optical phased array laser generally do not provide a way to phase lock the elements without use of some measurement external to the spatial beam combining assembly.

The classical science fiction portrayal of an optical phased array laser system resembles an electronically steerable array similar to that of a phased array radio frequency antenna or microwave frequency antenna that can be arbitrarily controlled to form a focused beam. The reality of an optical phased array is quite different. Prior approaches use some form of external measurement method to phase lock the plurality of beams in the spatial combiner assembly to one another. While some methods attempt to phase lock the plurality of beams to one another, these methods only do so relative to an arbitrary random spatial reference that would not phase the beam coherently when focused. The known prior methods could be calibrated for the error induced by this arbitrary random spatial reference, however, in many cases the methods will suffer and be degraded by random drift induced by thermal and/or mechanical drift over time and will have a sensitivity to drift on the scale of 10s of nanometer (nm) of drift in the optical paths that are not directly measured. Another potential method for phase locking an optical phased array may rely on measurements strictly internal to the spatial combining assembly. However, this approach has historically been subject to 10s of nanometer (nm) class alignment uniformity and mechanical stability requirements and is thus ineffective. Thermal and vibrational drift will exceed these requirements, making the potential methods non-viable and ineffective for phase control of an optical phased array. The general theme of known methods and prior attempts for phase locking an optical phased array is that the methods developed to date all require some sort of external measurement or require an external calibration that will be highly sensitive to drift, rendering the methods non-viable to provide a truly coherent and programmable output laser source.

What is needed is a robust method for measurement of the phase of the output beams relative to one another that does not require an external sensor. These, and other features and benefits, will become apparent to those of skill in the relevant arts by reference to the following descriptions and appended figures.

### SUMMARY

A robust method for measurement of the phase of the output beams relative to one another that does not require an external sensor has long eluded invention and development because the problem calls for a virtual measurement of a laser beam in a measurement plane that cannot be easily accessed without an external measurement sample optic and sensor. The embodiments described herein meet this need by providing a configuration that combines one or more of the following features: (a) a minimally intrusive beam sampling approach that contains information about the relative phase information between beams and can remain strictly internal to the spatial beam combiner assembly that arranges the output beams; (b) the non-intrusive beam samples are detected in a manner that does not have any non-common path error, leading to a thermally stable and mechanically robust configuration that can tolerate high levels of random fabrication error and/or thermal or vibrational drift; and (c) a processor configured to process the measurement data to control the array to enable precise measurement of the phase differences between beams, which in turn enables an accurate reconstruction of the spatial phase state of the array of beams at the optical phased array spatial combiner element output.

According to some embodiments, a method for generating phase difference measurements between neighboring output beams includes the steps of projecting a plurality of output beams, each output beam emanating from an associated output beam source; collimating the plurality of output beams by a plurality of lenses in a lens array; forming a plurality of sampling regions on an output window; directing, by the sampling regions, a sample of neighboring beam pairs back through the plurality of lenses; and forming, at a detector or optical capture feature such as a single mode waveguide or fiber directing light to a detector, a focused pair of beams.

The method may further include providing a pin aperture or hole at a focus of the focused pair of beams. In some cases, the optical paths from the sampling region to the detector or optical capture feature such as a single mode waveguide or fiber have a same path length.

According to some embodiments, a method for measuring a phase difference between neighboring output beams includes measuring, with a detector, an optical sample; demodulating a time series of subsequent optical samples to determine phase difference measurements; unwrapping the phase difference measurements to generate a phase estimate; adding the phase estimate to a beam steering or beam pattern phase offset to generate an error signal; and generating, by passing the error signal through an actuator filter and control block, phase command signals configured to modulate the phase of a beam sample at a channel control.

In some examples, the demodulating step includes a timing control signal. In some instances, the modulating and demodulating estimates a phase gradient by a two-point temporal modulation. The demodulation step may optionally include full circle reconstruction of the phase difference measurements.

In some cases, the method includes adjusting the phase offset by a calibration error offset. Optionally, the actuator filter and control block adds the phase command signals to a control output in accordance with timing signals and the actuator filter and control block may include one or more of a pure integrator, a proportional-integral controller, a leaky integrator controller, and a proportional-integral-derivative controller.

The method may include combining the neighboring output beams into a spatially combined projected beam.

According to some embodiments, a gradient interferometrically locked laser source includes a laser source configured to produce an optical beam; a beam splitter configured to split the optical beam into a plurality of output beams; a detector configured to receive the plurality of output beams; a demodulator configured to demodulate the plurality of output beams and further configured to determine phase difference measurements associated with the plurality of output beams; a phase unwrapper configured to receive the phase difference measurements and determine, based at least in part on the phase difference measurements, a phase estimate; an actuator filter and control block configured to receive the phase estimate and one or more of a beam steering offset, a beam pattern phase offset, and a calibration error offset and further configured to produce phase command signals to adjust one or more parameters of the plurality of output beams; and a combiner configured to spatially combine the output beams in an array to form a projected laser beam.

The gradient interferometrically locked laser source may further include a housing, and the laser source, the beam splitter, the detector, the demodulator, the phase unwrapper, and the actuator and filter control block are all located within the housing.

A particular advantage of embodiments described herein is that all, or nearly all, sensing and measurement is contained in the spatial combiner, which may be located within the housing, and no external measurement or phase sensors are required. An additional advantage of the disclosed embodiments is that no phase correction devices in a high-power segment of the projected laser beam path is required to compensate for both the aberrations in the plurality of optical beam transport and the amplifier channels. In addition, in some embodiments, the phase corrections are made using strictly high-speed null-seeking feedback control loops that are internal to the laser source and do not require feedback from a device external to the spatial combiner or the assembly holding and supporting the optical elements that enable projecting the phased array laser source, thus providing a robust method of compensation. The phase corrections further do not exhibit a round-trip time of flight data latency in the control loop. Some embodiments can control the combined output beam with electronically commanded offset values to electronically steer the beam. Further, some embodiments can control the combined output beam with electronically commanded offset values to form a desired arbitrary focused beam pattern up to the spatial bandwidth limitations of the array. Some embodiments can control the combined output beam with electronically commanded offset values to pre-compensate for aberrations in a beam transport or beam delivery system that points or focuses the beam, provided that the aberrations are measured, determined, or known by some other means, or otherwise ascertained. Some embodiments can control the combined output beam with electronically commanded offset values to pre-compensate for aberrations induced by propagation through a turbulent medium, provided that the aberrations are measured, determined, or known by some other means or otherwise ascertained. Similarly, embodiments can control the combined output beam with electronically commanded offset values to pre-compensate for aberrations in a beam transport or beam delivery system that points or focuses the beam combined with aberrations induced by propagation through a turbulent medium, provided that the aberrations are measured or known by some other means or otherwise ascertainable. Some embodiments can combine the aforementioned functions of pre-compensation for aberrations from the beam transport, beam transport, or turbulent medium, with beam steering or beam forming offsets.

Numerous methods in the literature can be used to measure the optical path in the beam transport or beam delivery system. Numerous methods in the literature can be used to measure the aberrations induced by propagation through a turbulent medium. However, embodiments described herein have additional benefits and functionality not achievable by known structures or methods, and in particular, some of the disclosed embodiments are configured to produce a coherent optical beam phased to an arbitrary desired phase measurement pattern, without requiring an external measurement device or sensor.

As such, according to some examples, embodiments described herein provide a structure and method for forming a coherent optical phased array laser source from a spatially combined array of output beams without use of an external measurement device or wavefront sensor. According to some embodiments, all the measurements needed to form the coherent optical beam are internal to the device. In some cases, one or more features are included in example embodiments, namely: (a) a minimally intrusive beam sampling approach that contains information about the relative phase information between beams and can remain strictly internal to the spatial beam combiner assembly that arranges the output beams; (b) the non-intrusive beam samples are detected in a manner that does not have any non-common path error, leading to a thermally stable and mechanically robust configuration that can tolerate high levels of random fabrication error and/or thermal or vibrational drift; and (c) a processor for processing the measurement data to control the array to enable precise measurement of the phase differences between beams, which in turn enables an accurate reconstruction of the spatial phase state of the array of beams at the optical phased array spatial combiner element output. In some cases, all three of these features may be included in combination with these or other features.

A summary of features contained in the various embodiments is contained herein. In some examples, a method is designed for use with a master oscillator laser that is split into a plurality of optical beam transport and amplifier channels to produce a plurality of optical output beams that are spatially combined by a spatial combiner in an array format. The method may provide a way to measure the spatial phase state of the plurality of output beams at the output of a spatial combiner without use of an external measurement device or sensor. This in turn can enable the method to control the phase of the plurality of optical output beams to compensate both for aberrations induced by the optical beam transport and amplifier paths to produce a coherent and spatially phased laser beam at the output of the laser source or to produce a phased laser beam with prescribed phase state on each output beam. In some cases, a benefit is that all sensing and measurement may be contained in the spatial combiner and no external measurement or phase sensor is required. An additional advantage may be that no phase correction device in a high-power segment of the projected laser beam path is required to compensate for both the aberrations in the plurality of optical beam transport and the amplifier channels. In addition, the phase corrections can be made using strictly high-speed null-seeking feedback control loops that are internal to the laser source and do not require feedback from a device external to the spatial combiner or the assembly holding and supporting the optical elements that enable projecting the phased array laser source, thus providing a robust method of compensation. According to some embodiments, the phase corrections do not have, or do not exhibit, round-trip time of flight data latency in the control loop. Some embodiments can control the combined output beam with electronically commanded offset values to electronically steer the beam. Some embodiments can be configured to control the combined output beam with electronically commanded offset values to form a desired arbitrary focused beam pattern up to the spatial bandwidth limitations of the array. Similarly, some embodiments can control the combined output beam with electronically commanded offset values to pre-compensate for aberrations in a beam transport or beam delivery system that points or focuses the beam, provided that the aberrations are measured, determined or known by some other means. Some embodiments can control the combined output beam with electronically commanded offset values to pre-compensate for aberrations induced by propagation through a turbulent medium, provided that the aberrations are measured or known by some other means. Similarly, embodiments disclosed herein may be configured to control the combined output beam with electronically commanded offset values to pre-compensate for aberrations in a beam transport or beam delivery system that points or focuses the beam combined with aberrations induced by propagation through a turbulent medium, provided that the aberrations are measured or known by some other means. Some embodiments described herein can combine the aforementioned functions of pre-compensation for aberrations from the beam transport, beam transport, or turbulent medium, with beam steering or beam forming offsets.

According to some embodiments, a method for generating measurement signals related to a plurality of phase differences between neighboring output beams, includes the steps of projecting a plurality of output beams, each output beam emanating from an associated output beam source; tailoring a collimation state of the plurality of output beams by a plurality of lenses in a lens array; forming a plurality of sampling regions on an output window; directing, by the sampling regions, a sample of neighboring beam pairs back through the plurality of lenses to form a focused pair of beams; and producing, by a detector, an optical sample signal associated with the focused pair of beams. As used herein, tailoring the collimation state refers to adjusting the convergence or divergence of a plurality of output beams. In some cases, tailoring the collimation state causes two or more beams to become more convergent, more divergent, or more parallel.

In some cases, an optical path length from the sampling regions to the detector is substantially the same between each pair of beams. That is, the optical path length is the same within a predetermined standard deviation tolerance distance. In some cases, the tolerance distance is within about 1% to about 10% of the optical wavelength. Therefore, as used herein, where the optical path length is substantially the same between each pair of beams, the optical path length is within about 10% of the optical wavelength of the projected beams, where the numerical value is given by way of example and not by way of limitations and the specific requirement will depend on the application of interest.

The method may further include providing an aperture at a focus of the focused pair of beams to form a sample of the focused pair of beams. A detector may be located after the aperture and may measure the sample of the focused pair of beams.

In some embodiments, an optical capture device is located at the focus of the focused pair of beams and directs a sample of the focused pair of beams to the detector. The optical capture device may be a single mode waveguide. In some instances, the optical capture device is an optical fiber.

The method may further include combining the neighboring beam pairs into a spatially combined projected beam.

According to some embodiments, a method for measuring phase values of a plurality of beams includes measuring, with a detector, optical sample signals related to a phase difference between neighboring beams; demodulating a time series of subsequent optical sample signals to determine phase difference measurements; and unwrapping the phase difference measurements to generate a phase estimate. The demodulating step may comprise a timing control signal.

In some cases, the modulating and demodulating steps estimate a phase gradient, such as by a two-point temporal modulation. The demodulating step may comprise full circle reconstruction of the phase difference measurements.

The method may further include the step of adjusting the phase estimate by a calibration error offset.

According to some embodiments, a method for coherently combining a plurality of beams includes projecting a plurality of output beams, each output beam emanating from an associated output beam source; tailoring a collimation state of the plurality of output beams by a plurality of lenses in a lens array; forming a plurality of sampling regions on an output window; directing, by the sampling regions, a sample of neighboring beam pairs back through the plurality of lenses to form a focused pair of beams; producing, by a detector, an optical sample signal of the focused pair of beams; demodulating a time series of subsequent optical sample signals to determine phase difference measurements; unwrapping the phase difference measurements to generate a phase estimate; adding the phase estimate to a beam steering or beam pattern phase offset to generate an error signal; and generating, by passing the error signal through an actuator filter and control block, phase command signals configured to modulate the phase of a beam sample at a channel control. In some cases, an optical path length from the sampling regions to the detector is substantially the same between each pair of beams.

In some instances, the method may include providing an aperture at a focus of the focused pair of beams to form a sample of the focused pair of beams. The detector may be located after the aperture and the method may further include measuring, by the detector, the sample of the focused pair of beams.

In some cases, an optical capture device is located at the focus of the focused pair of beams and the method may include directing, by the optical capture device, the sample of the focused pair of beams to the detector. In some examples, the optical capture device is one or more of a single mode waveguide or an optical fiber.

The method may include combining the plurality of output beams into a spatially combined projected beam. In some examples, the actuator filter and control block are configured to add the phase command signals to a control output in accordance with timing signals. The actuator filter and control block may comprise one or more of a pure integrator, a proportional-integral controller, a leaky integrator controller, and a proportional-integral-derivative controller.

According to some embodiments, a method for generating measurement signals related to a plurality of phase differences between neighboring output beams of an optical beam generator, includes the steps of projecting a plurality of output beams, each output beam emanating from an associated output beam source; tailoring a collimation state of the plurality of output beams by a plurality of lenses in a lens array; forming a plurality of sampling regions on an output window; directing, by the sampling regions and to a detector producing an optical sample signal associated with the plurality of output beams. In some cases, an optical path length from the sampling regions to the detector is substantially the same between each pair of beams.

According to some embodiments a gradient interferometrically locked laser source, comprises a laser source configured to produce an optical beam; a beam splitter configured to split the optical beam into a plurality of output beams; a plurality of channel control devices configured to control a phase of the plurality of output beams and apply a modulation pattern to enable measurement of phase differences between the plurality of output beams; a beam combiner configured with a plurality of lenses to spatially combine the plurality of output beams in an array to form a projected laser beam; an output window having a plurality of sampling regions configured to direct samples of neighboring beam pairs back through the plurality of lenses to form a plurality of focused pairs of beams; a plurality of detectors configured to produce a plurality of optical sample signals associated with the plurality of focused pairs of beams; a demodulator configured to demodulate the plurality of output beams and further configured to determine phase difference measurements associated with the plurality of output beams; a phase unwrapper configured to receive the phase difference measurements and determine, based at least in part on the phase difference measurements, a phase estimate; and an actuator filter and control block configured to receive the phase estimate and one or more of a beam steering offset, a beam pattern phase offset, and a calibration error offset and further configured to produce phase command signals to adjust one or more parameters of the plurality of output beams. An optical path length extends from the plurality of sampling regions to the plurality of detectors, and the optical path length may be substantially the same for each of the plurality of focused pairs of beams.

The gradient interferometrically locked laser source may comprise a plurality of apertures, wherein individual ones of the plurality of apertures are located at a focus of each of the plurality of focused pairs of beams. The plurality of detectors may be positioned downstream of the plurality of apertures.

In some cases, the system includes a plurality of optical capture devices, wherein individual ones of the plurality of optical capture devices are configured to direct a sample of the focused pairs of beams to the plurality of detectors. The plurality of optical capture devices may be single mode waveguides.

In some embodiments, a housing encompasses the beam splitter, the plurality of channel control devices, the beam combiner, the output window, and the plurality of detectors. In other words, a system and method are provided for robust measurement of the phase of the output beams relative to one another that does not require any external sensors.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 is a schematic of a generic optical phased array laser source that describes the general class of laser sources, in accordance with some embodiments.

FIGS. 2A and 2B schematically illustrate the pattern of a plurality of output beams for a rectilinear array, in accordance with some embodiments.

FIG. 3 is a schematic that illustrates the pattern of a plurality of output beams for a hexagonal array, in accordance with some embodiments.

FIG. 4 is a schematic that illustrates a contemplated example of a spatial combiner embodying a cross-section of a sampling scheme for generating phase difference measurements between neighboring output beams when combined with an appropriate phase modulation scheme for alternating beams, in accordance with some embodiments.

FIG. 5 is a sample schematic of one example of signal processing that is used to modulate a sample of the plurality of output beams with a small amplitude modulation that enables measurement of the phase differences between neighboring output beams.

FIG. 6 is a sample process flow for generating measurement signals associated with phase differences between neighboring output beams, in accordance with some embodiments.

FIG. 7 is a sample process flow for measuring phase values of optical beams, in accordance with some embodiments.

FIG. 8 is a sample process flow for coherently combining a plurality of optical beams, in accordance with some embodiments.

FIG. 9 is a sample process flow for generating measurement signals related to a plurality of phase differences between output beams, in accordance with some embodiments.

### DETAILED DESCRIPTION OF THE DRAWINGS

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

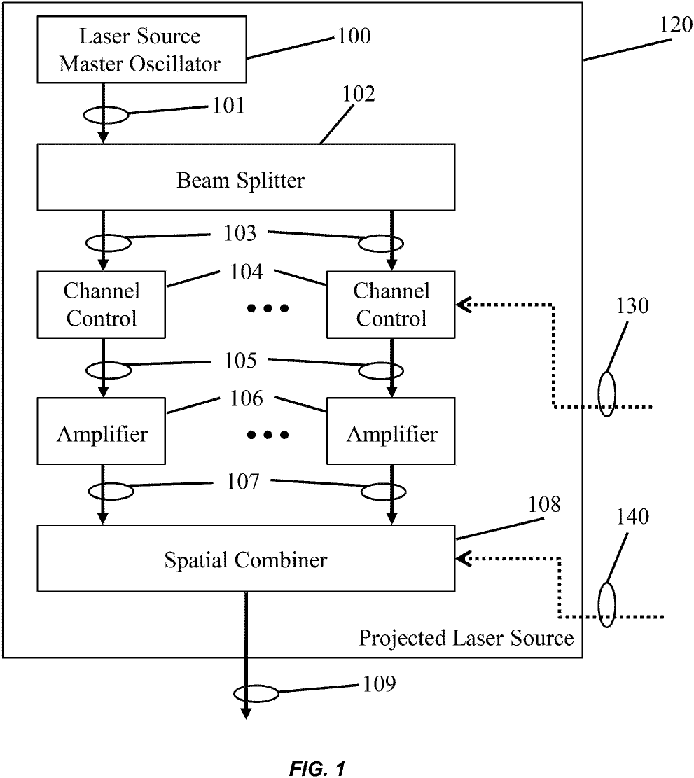

FIG. 1 is a schematic of a generic optical phased array laser source that describes the general class of laser sources suitable for use with embodiments described herein. The optical phased array laser source of interest may include a master oscillator laser source, a beam splitter and associated optical transport to produce a plurality of optical output channels that are each equipped with a channel controller and amplifier, and a spatial beam combiner with a plurality of optional integrated tip/tilt devices and/or optional integrated focus control devices.

The channel controllers may include a phase modulator and optionally include a polarization control and/or a path length controller. The optical phased array laser source produces an output projected laser beam. The optical phased array laser source also may include inputs for control of the plurality of channel controllers and an optional input for control of the plurality of optional integrated tip/tilt devices and/or optional focus control devices. FIG. 1 is shown by way of example and not of limitation. There are alternate ways of controlling and/or displaying the laser path(s) as those skilled in the art would recognize.

Shown in FIG. 1 is the laser source master oscillator 100. In some embodiments, the laser source master oscillator 100 functions to produce the master oscillator beam 101. The master oscillator beam 101 may encounter a beam splitter 102 that is configured to produce a plurality of low power beam samples 103. For example, the beam splitter 102 may be configured to bifurcate the master oscillator beam into two, three, four, or more low power beam samples 103. The plurality of low power beam samples 103 may be modulated by a plurality of channel controllers 104, and in some cases, each of the lower power beam samples 103 is fed through a unique channel controller 104. The channel controller 104 may be configured to produce a plurality of modulated low power beam samples 105. The plurality of channel controllers 104 can be implemented by any of a number of channel controllers known to those skilled in the art to control the individual low power beam samples 103 coming from the beam splitter 102. These methods include, but are not limited to, electro-optical phase modulators, acousto-optic modulators, in-line fiber electro-optical phase modulators, in-line fiber acousto-optic modulators, and/or modulation of the current to the optical amplifiers 106. Of course, combinations of various channel controllers may be implemented simultaneously and may be disposed serially or in parallel. In addition to a phase modulator, each channel of the channel controllers 104 may optionally include a polarization control and/or a path length controller. The plurality of modulated low power beam samples 105 may in turn be amplified by a plurality of optical amplifiers 106 that may function to produce a plurality of high-power beam samples 107. The plurality of high-power beam samples 107 can be combined with a spatial beam combiner 108 which may function to package the output beams as closely as possible / practical. Beams are typically packaged in a rectilinear output pattern or a hexagonal output pattern; however, these particular packing patterns are not required, and the pattern can be optimized for the application of interest through any suitable geometric or spatial packing pattern.

There are multiple ways to implement the spatial beam combiner 108 that are well known to those skilled in the art, including but not limited to, an array of optical fibers configured with a corresponding array of collimating lenses, diffractive optical elements, and/or beam splitter elements. Each channel of the spatial beam combiner 108 may optionally include an integrated device to control tip/tilt of each channel to provide improved compensation. Further, each channel of the spatial beam combiner 108 can optionally include an integrated device to control focus of each channel to provide improved compensation. In some cases, the output of the spatial beam combiner 108 is the projected laser source beam 109. In some cases, the projected laser source beam 109 is composed of a spatially tiled plurality of projected laser beams. The beam transport pathway from the laser source master oscillator 100 to the spatial beam combiner 108 can be implemented by one of several means well known to those skilled in the art. In some embodiments, a single mode optical fiber connects each element of the optical chain from the laser source master oscillator 100 to the spatial beam combiner 108, which optionally can be polarization-maintaining.

Of course, those of skill in the art will recognize that any other suitable optical beam transport means can be utilized. For example, an optical beam transport means that has a limited number of optical modes and that can be corrected in full by phase piston modulation, tip/tilt modulation, and/or focus modulation can be utilized.

In addition to the phase modulator for the channel controllers 104, there are several other components that may be beneficial in the channel controllers 104. These include, but are not limited to devices such as polarization controls, path length adjusters, and line broadening devices, among others.

For example, if a non-polarization maintaining fiber or any other non-polarization-maintaining beam transport devices are utilized, then the plurality of channel controllers 104 may further include a plurality of polarization controls that may function to stabilize the polarization of each of the channels relative to one another to ensure a common polarization state is maintained. Typically, a gradient optimization method can be utilized to ensure a common polarization state is maintained.

If the coherence length of the master oscillator 100 is small relative to the total path length tolerances, then the channel controllers 104 may further include one or more path length adjustment devices that may function to adjust the path length as desired to encourage the projected laser source beam 109 to be path length matched to within a fraction of the coherence length.

If the plurality of optical amplifiers 106 require a short coherence length (i.e. a broad linewidth) of the plurality of modulated low power beam samples 105 in order to provide effective amplification, then the beam transport means may include one or more line-broadening devices that function to broaden the linewidth of the plurality of modulated low-power beam samples 105. Typically, this will be accomplished by use of a single line-broadening device installed immediately following the master oscillator 100 but could also be accomplished by use of a plurality of line-broadening devices installed appropriately in the beam transport pathway. If a line-broadening device is incorporated, such as to shorten the coherence length, then path length adjustment devices may be provided accordingly.

In some cases, the totality of elements including the laser source master oscillator 100, the beam splitter 102, the plurality of channel controllers 104, the plurality of amplifiers 106, and the spatial combiner 108, are considered the projected laser source 120. The projected laser source 120 may have a plurality of output beams already described as the projected laser source beam 109. In some cases, the projected laser source 120 may have two additional input sources: the input channel control signal 130 (which may include phase modulator control signals, optional polarization control signals, and/or optional path length controller configured to modify the control signals), and the optional input tip/tilt/focus control signal 140. The projected laser source 120 may include a housing that contains the described components illustrated in FIG. 1.

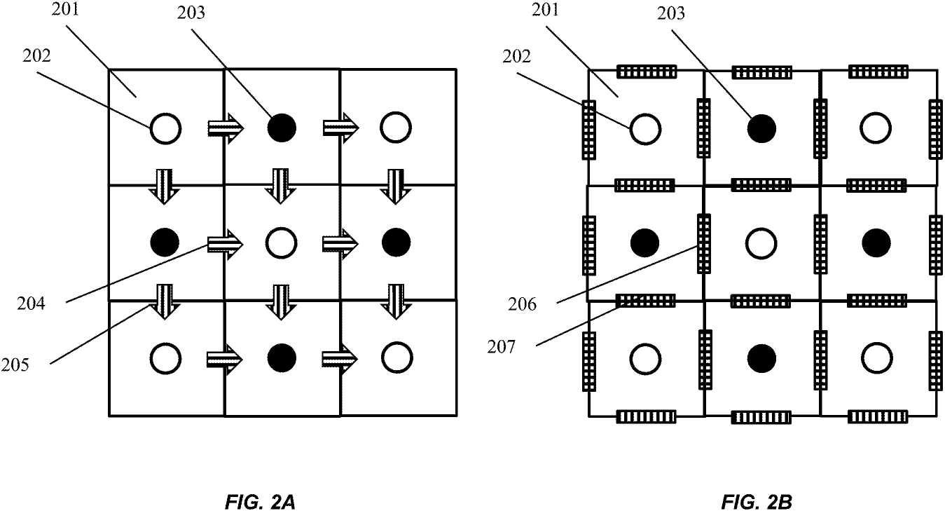

FIGS. 2A and 2B are schematic illustrations that demonstrate an example pattern of a plurality of output beams for a rectilinear array, in accordance with some embodiments. In some cases, each beam passes through a collimating lens 201 arranged in a lens array. Alternating beams are labeled as non-modulated beams 202 (with an open circle) and modulated beams 203 (with a filled circle). The modulation can be used to obtain X-direction phase difference measurements 204 and Y-direction phase difference measurements 205. The “arrows” are shown by way of example and not of limitation and to provide a notional coordinate system.

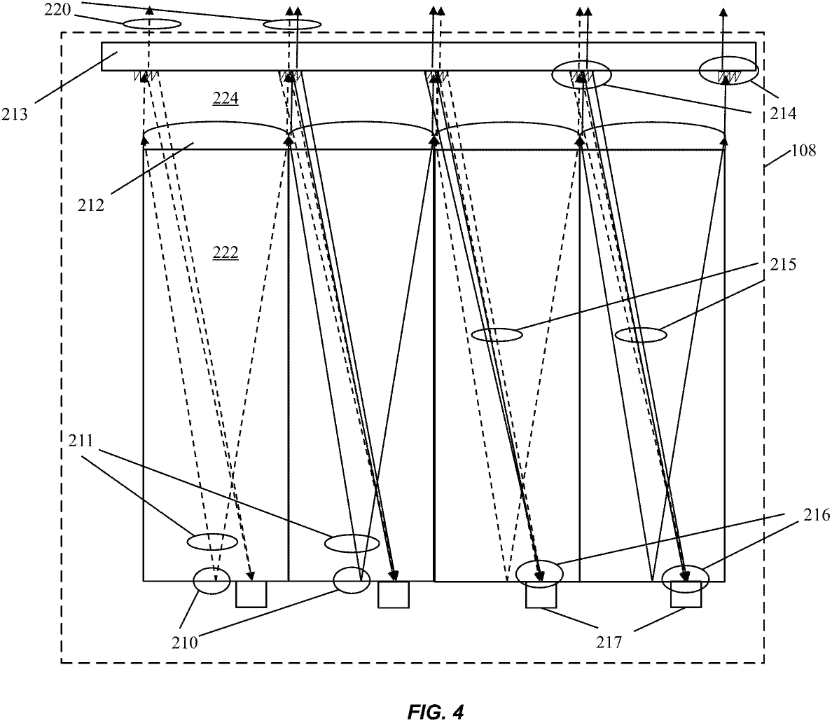

The choice of alternating modulating and non-modulating beams 202, 203 are shown by way of example and not of limitation and there are numerous other modulation schemes that will be apparent to those skilled in the art. The X-sampling region 206 and Y-sampling region 207 between the beam output lenses notionally show the area over which a phase difference measurement can be made following the method detailed in FIG. 4. The sizing of the sampling regions may be balanced for sufficient contrast ratio, signal to noise ratio, and/or to minimize throughput losses. The X and Y-sampling regions are shown by way of example and not of limitation. FIG. 2 is shown by way of example and not of limitation. There are alternate ways of arranging the output beams (other than a hexagonal or rectilinear array) or selecting the modulation pattern as those skilled in the art would recognize in light of the present disclosure.

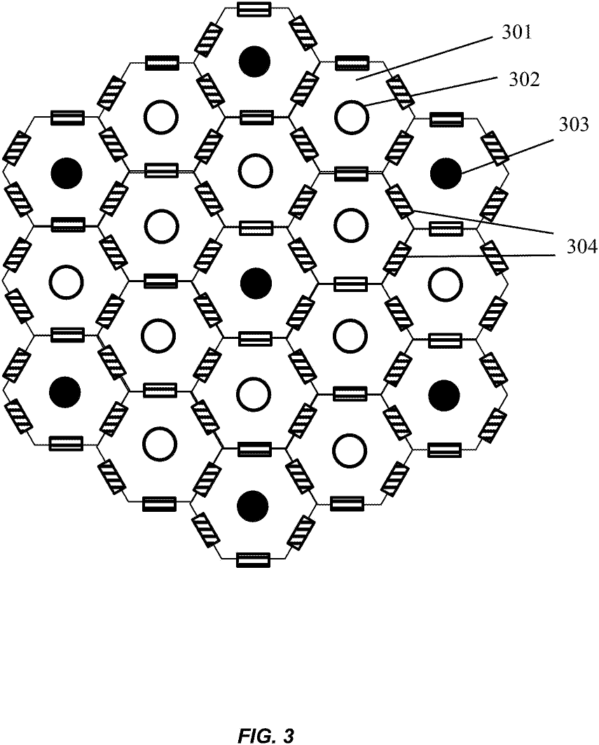

FIG. 3 is a schematic that illustrates the pattern of a plurality of output beams for a hexagonal array. Each beam may pass through a collimating lens 301 arranged in a lens array. Alternating beams are labeled as non-modulated beams 302 (with an open circle) and modulated beams 303 (with a filled circle). The modulation may be used to obtain phase difference measurements over sampling regions 304 in the 3 different directions defined by the array. We do not show directional arrows in this figure as the directional arrow conventions can be selected by the system designer as well be recognized by those skilled in the art. The choice of alternating modulating and non-modulating beams are shown by way of example and not of limitation and there are numerous other modulation schemes that will be apparent to those skilled in the art. The sampling regions 304 between the beam output lenses notionally show the area over which a phase difference measurement will be made following the method detailed in FIG. 4. The sampling regions are shown by way of example and not of limitation. In some cases, the sizing of the sampling regions may be balanced for sufficient contrast ratio, signal to noise ratio, and to minimize, or at least reduce, throughput losses. FIG. 3 is shown by way of example and not of limitation. There are alternate ways of arranging the output beams (other than a hexagonal or rectilinear array) or selecting the modulation pattern as those skilled in the art would recognize.

FIG. 4 is a schematic diagram that illustrates a cross-section of the sampling scheme for generating phase difference measurements between neighboring output beams when combined with an appropriate phase modulation scheme for alternating beams, in accordance with some embodiments. In some cases, the components and methods described in relation to FIG. 4 are located and performed in the spatial beam combiner 108. The plurality of output beam sources 210 may be projected to form a plurality of output beams 211. The output beams 211 are shown by way of example and not of limitation as diverging but there are numerous configurations that will be apparent to those skilled in the art, such as converging, parallel, colinear, crossing, non-planar, etc. For efficiency in describing the system, the output beam sources 210 are shown as point sources (i.e. as in from a single mode fiber or waveguide of some sort) but there are numerous configurations for laser sources that will be apparent to those skilled in the art.

The plurality of beams 211, if diverging, may be collimated by one or more lenses 212 which may be arranged as a lens array. A plurality of sampling regions 214 can be formed on an output window 213. The plurality of non-collimated beams project through an output window 213 and may be sampled by the sampling regions 214. In some embodiments, the output window 213 is a flat optic that is manufactured with sufficiently low absorption glass so that the output window 213 does not heat excessively and lead to non-common path unmeasured wavefront error. Manufacturing of such a window is low risk to reach sufficiently tight tolerances and to use low absorption glass so as to not have an impact on the performance of the optical phased array laser source as a whole. As known to those skilled in the art, a window is commonly required for environmental protection of a laser source if used for industrial, defense, or any other outdoor or space-based applications. The sampling regions 214 can be attached by any suitable method; however, in some cases, the sampling regions 214 are attached by epoxy (low absorption and index-matched) or etched directly into the output window.

The sampling regions 214 may be a partial reflector or a reflector. In some examples, the sampling regions can be fabricated as a flat surface or a grating. The sampling regions 214 may be manufactured and integrated using a range of options or methods and as long as they are substantially flat locally to the sampling region (to within reasonable fabrication tolerances) then there will not be non-common path error introduced into the measurement. The tilt accuracy of the sampling regions 214 may be determined and is commonly dependent on the details of the engineering configuration. In some cases, the tilt accuracy tolerance has some impact on the quality of the wavefront that is achieved in closed loop operation at steady state but studies to date indicate the tolerances are on the order of 0.1 to 0.5 waves root-mean-square (RMS) error relative to the beam pitch which is reasonable. The sampling regions 214 may be configured to direct a sample of neighboring beam pairs 215 back through the plurality of collimating lenses 212 to form a focused pair of beams 216 at a detector 217.

The one or more lenses 212 may be supported by a structure that locates and orients the one or more lenses 212 to direct the beams as described herein. The structure may further be configured to support the output window 213 with sampling regions a distance from the one or more lenses 212. Further, the structure may further support the detectors 217 a fixed distance from the one or more lenses 212. In some cases, the distance between the one or more lenses 212 and the detectors 217 defines a first space 222 and the distance between the one or more lenses 212 and the output window 213 defines a second space 224.

In some cases, the detector 217 utilizes a small pinhole at the focus to ensure that the interference measured by the detector 217 approximately measures the average of the complex field over the sampling region. If the complex fields are not averaged via some means, then there will be no interference and thus the phase difference is difficult to measure. In some cases, the optical paths are the same path length from the sampling region to the detector pinhole. The common path length may help to avoid non-common path error in the phase difference measurement, which can lead to a degradation in performance.

According to some embodiments, the plurality of collimating lenses 212 provides a convenient way to focus the beams, which, provided that the collimating lens is properly designed, will have no non-common path error to the pinhole at the focal plane. The pinhole can be implemented by numerous ways well known to those skilled in the art. For example, a single mode fiber or waveguide can be used and then the fiber or waveguide can be routed to a separate detector. Alternately, a physical pinhole with size of roughly the diffraction limited spot can be used. The sizing (or equivalently numerical aperture) of the pinhole is an engineering trade to balance sensitivity to tilt of the sampling regions 214 with signal to noise ratio. Generally, there will be a very large amount of light available and the trade may be based on sensitivity to tilt accuracy of the sampling regions. In some examples, the exit beams 220 are collimated beams that exit the output window 213.

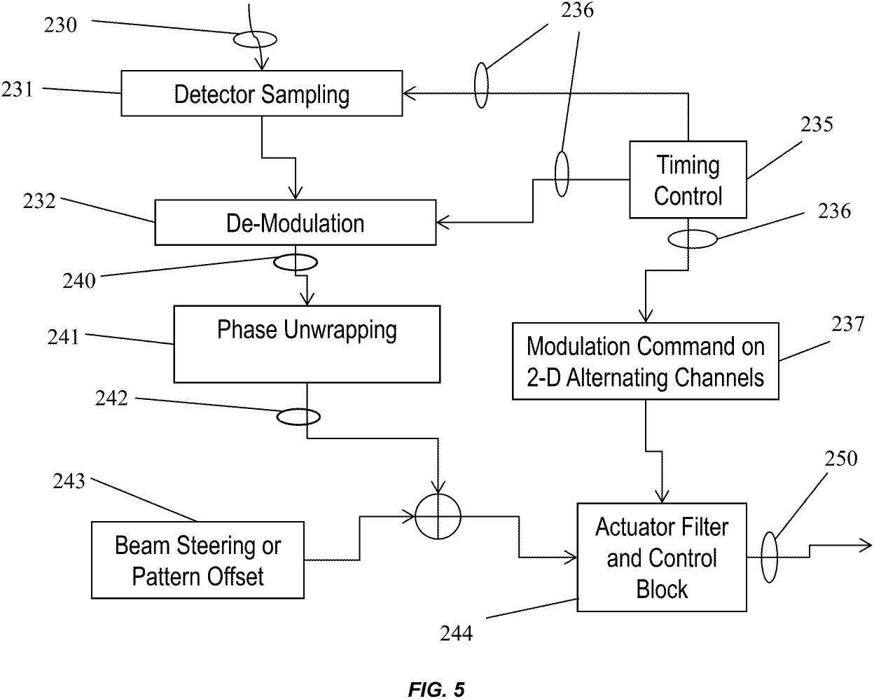

In some cases, the beams 211 originate at the beam source 210 and travel through the first space 222 between the beam source 210 and the lenses 212. The beams 211 then pass through the one or more lenses 212 and enter a second space 224 between the lenses 212 and the output window 213. In some embodiments, the beams 211, or a portion of the beams 211, are reflected at the sampling regions 214 back through the second space 224, through the lenses 212, through the first space 222, and to the detectors 217. FIG. 4 is shown by way of example and not of limitation. There are numerous alternate configurations to FIG. 4 that will be recognized by those skilled in the art. According to some embodiments, an optical configuration provides a sampling of approximately the complex field over a sampling region that includes samples of the neighboring beams, that when combined with some sort of modulation and demodulation scheme as described by FIG. 5, will provide phase difference measurements between neighboring beams to enable controlling the output beam phase to a uniform condition. For example, additional geometries are contemplated and possible while taking advantage of the features described herein. For instance, multiple beam pairs could each be directed to a common detector. A system could employ a hexagonal geometry in which optical path lengths could be matched at vertices with groups of three beams and locating the sampling region at a corner. In such cases, a modulation pattern could be configured or adjusted to account for the specific geometry. Similarly, a square geometry could be employed in which groups of four beams are directed to a sampling region in a corner.

FIG. 5 is a schematic of the signal processing that is used to modulate a sample of the plurality of output beams with a small amplitude modulation that enables measurement of the phase differences between neighboring output beams, in accordance with some embodiments. In some examples, the phase differences can be unwrapped or “reconstructed” to form a phase error estimate. In some cases, the phase difference are processed by a component referred to as an “unwrapper” which may be any device, circuit, or software program that is configured to determine the phase differences to form a phase error estimate. The phase error estimate can be added to an optional beam steering or beam pattern offset to either (a) steer the beam; (b) apply a phase to form a pattern when focused; and/or (c) pre-compensate the beam for other aberrations in the system and/or for propagation through a turbulent medium (or any combination of the above). In some cases, the resultant sum of the error phase estimate and the offset pattern may then be converted to a command output (typically through a leaky integrator or pure integrator controller) and the small amplitude modulation commands to enable measurement of the phase difference are added to the command signal before sending the command to the phase modulator.

Each optical sample 230 from the plurality pair of neighboring beams may be measured with a detector sampling device 231 such as one of the detectors 217 illustrated in FIG. 4. The time series of detector measurements may be demodulated via signal processing in a demodulator 232 to produce phase difference measurements 240. In some embodiments, the timing controller 235 ensures that timing signals 236 are routed to the detector sampling device 231, the demodulator 232, and the modulation command device 237, which may operate on 2-D alternating channels with the proper timing to enable effective modulation and demodulation of the phase difference between neighboring beams to produce phase difference measurements 240. There are numerous possible modulation and demodulation schemes well known to those skilled in the art. As an example, one of the more efficient approaches is to estimate the phase gradient by a 2-point temporal modulation with small amplitude to estimate a value that is approximately proportional to the phase difference between the neighboring output beams with small amplitude error signals. The demodulation may be computation of the gradient in this case, and may be performed by any suitable demodulator, which may be an electronic circuit, or in some cases, a computer program stored in memory and executed by one or more processors.

An alternate approach may use the classical Carre Method or a variation or hybrid method. These methods allow for full unit circle reconstruction of the phase difference using a small amplitude 4-point or 5-point temporal modulation pattern. In some cases, this approach preserves full unit circle phase difference information and avoids potential local minima and convergence errors associated with gradient-based hill-climbing methods or other gradient-based methods. The phase difference measurements 240 may be processed by a phase unwrapping scheme 241 to produce a phase estimate 242. There are numerous options for phase unwrapping 241; however, one approach that is straightforward to implement and practice is the “Complex Exponential Reconstructor”, or CER. The phase estimate 242 can be added to an optional beam steering or beam pattern phase offset 243 if the desired output beam array is to form a steered beam when focused or to form a specific pattern when focused. The phase offset 243 may also include a calibration error offset. It is expected that there will be some small calibration error that can be optimized for performance of the focused beam. The resultant sum of the phase estimate 242 and phase offset 243 can be processed with an actuator filter and control block 244. The actuator filter and control block 244 may be configured to process the error signal via some means to convert the error signal to phase command signals 250 (e.g., the input channel control signal 130) that modulate the phase modulators in the channel controllers 104. The actuator filter and control block 244 may also add the modulation commands to the control output in accordance with the timing signals 236. The actuator filter and control block 244 can be implemented via any suitable method, such as, without limitation, pure integrator, a proportional-integral controller, a leaky integrator controller, or a proportional-integral-derivative controller. The choice of the controller may be based on the engineering specifics of the implementation and design of the controller is well known to those skilled in the art.

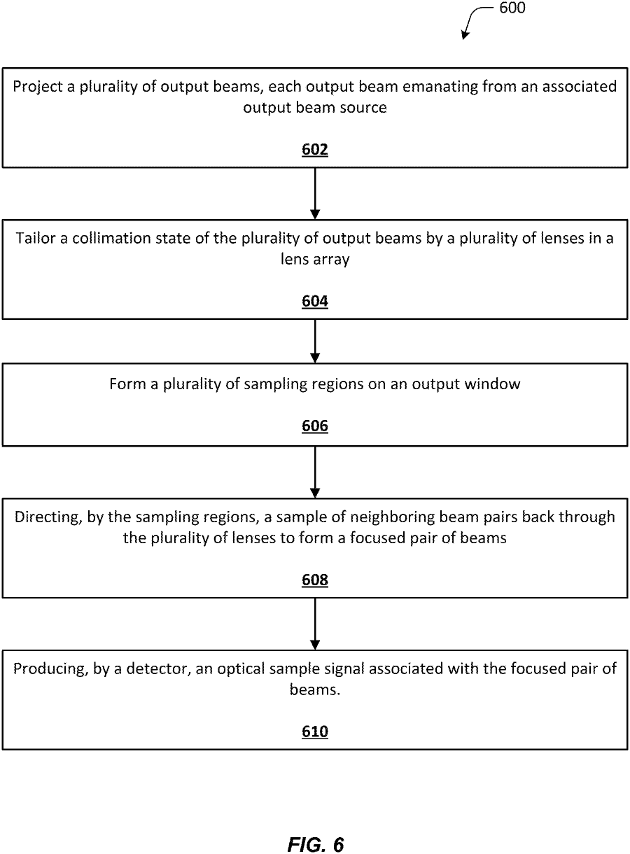

FIG. 6 illustrates a sample process flow for generating measurement signals associated with phase differences between neighboring output beams 600. The process may be as substantially described in reference to any of the embodiments herein. The process includes, at block 602, projecting a plurality of output beams from an output beam source. At block 604, the collimations state of a plurality of output beams is tailored by a plurality of lenses in a lens array. In some cases, each output beam passes through an individual lens.

At block 606, a plurality of sampling regions is formed on an output window. The sampling regions may show the area over which a phase difference measurement will be made. The beam, or a portion of the beam, may be reflected by the sampling regions, at block 608, back through the lenses to form a focused pair of beams.

At block 610, a detector produces an optical sample signal associated with the focused pair of beams.

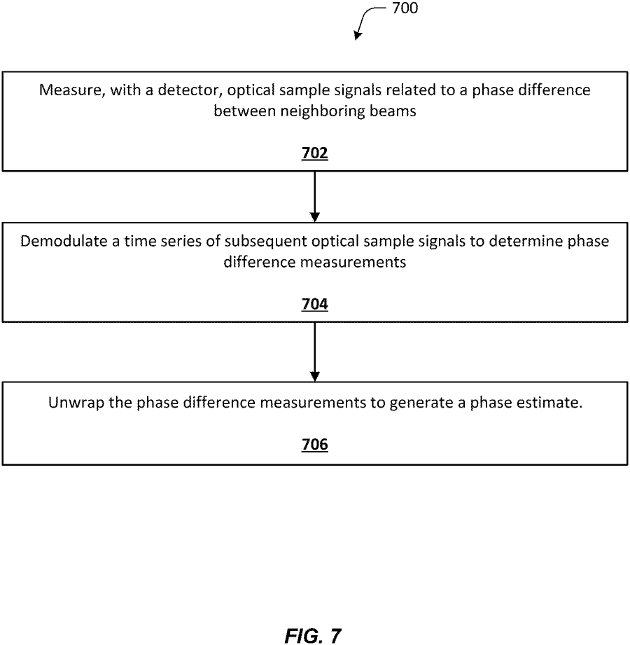

FIG. 7 illustrates a sample process flow for measuring phase values of optical beams 700. At block 702, a detector is used to measure optical sample signals related to a phase difference between neighboring beams. At block 704, phase difference measurements are determined by demodulating a time series of subsequent optical sample signals. At block 706, the phase difference measurements are unwrapped to generate a phase estimate. The phase estimates can be added and the resultant sum of the error phase estimate and the offset pattern may be converted to a command output and the small amplitude modulation commands to enable measurement of the phase difference may be added to the command signal before sending the command to the phase modulator.

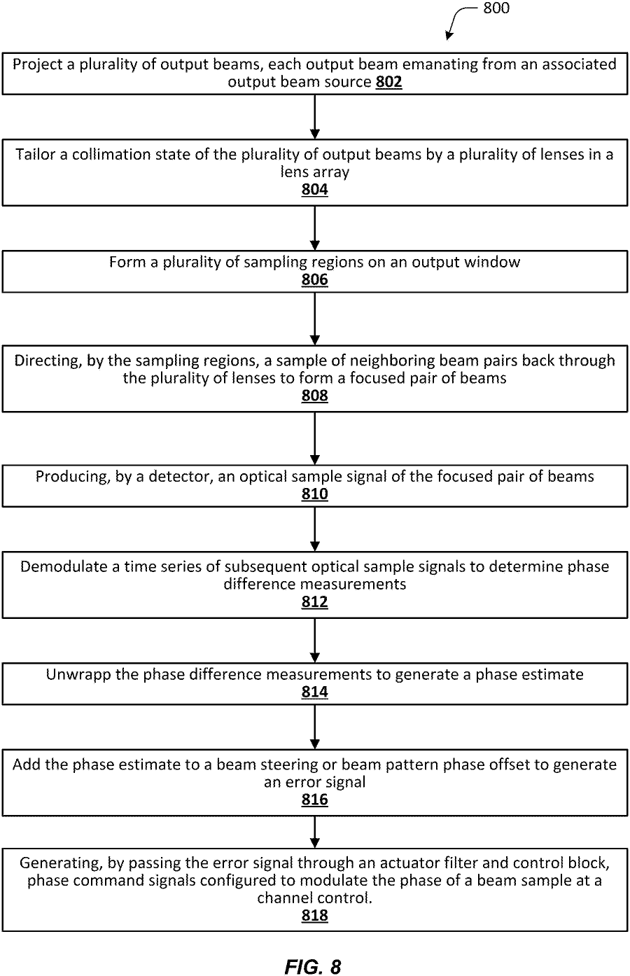

FIG. 8 illustrates a sample process flow for coherently combining a plurality of optical beams 800. At block 802, the system projects a plurality of output beams where each output beam emanates from an output beam source. At block 804, the system tailors a collimation state of the plurality of output beams by a plurality of lenses in a lens array. At block 806, the system forms a plurality of sampling regions on an output window, as substantially disclosed in any embodiment herein. At block 808, the system directs, by the sampling regions, a sample of neighboring beam pairs back through the plurality of lenses to form a focused pair of beams.

At block 810, a detector is used to produce an optical sample signal associated with the focused pair of beams. At block 812, the system demodulates a time series of subsequent optical sample signals to determine phase difference measurements. At block 814, the system unwraps the phase difference measurements to generate a phase estimate.

At block 816, the system adds the phase estimates to a beam steering or beam pattern phase offset to generate an error signal. At block 818, the system generates, based at least in part by passing the error signal through an actuator filter and control block, phase command signals configured to modulate the phase of a beam sample at a channel control. The resulting beams may be combined into a spatially combined projected beam.

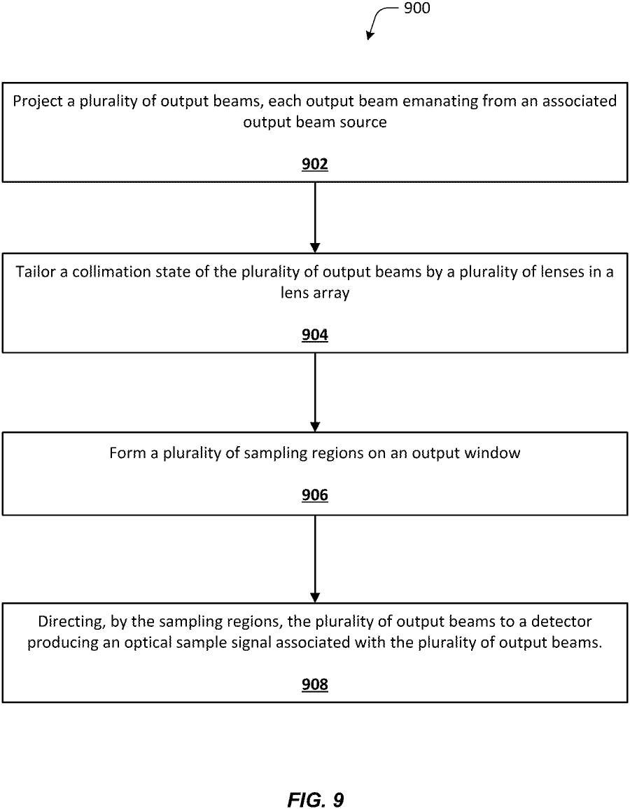

FIG. 9 illustrates a sample process flow for generating measurement signals related to a plurality of phase differences between output beams 900. At block 902 a plurality of output beams is projected from a beam source. At block 904, the collimation of the output beams is tailored by a plurality of lenses in a lens array. The lens array may be spaced a first distance from the beam sources. At block 906 a plurality of sampling regions is formed on an output window. At block 908, the sampling regions direct the plurality of output beams to a detector that produces an optical sample signal associated with the plurality of output beams.

The disclosure sets forth example embodiments and, as such, is not intended to limit the scope of embodiments of the disclosure and the appended claims in any way. Embodiments have been described above with the aid of functional building blocks illustrating the implementation of specified components, functions, and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.”

For ease of use, the terms “including” and “having” (and their derivatives), as used in the specification and claims, are interchangeable with and shall have the same meaning as the word “comprising. As used herein, the terms “about,” and “approximately,” may, in some examples, indicate a variability of up to ±5% of an associated numerical value, e.g., a variability of up to ±2%, or up to ±1%.

Throughout the specification, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, 97% met, or even at least approximately 99% met.

A processor may be configured with instructions to perform any one or more steps of any method as disclosed herein.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

As used herein, the term “or” is used inclusively to refer items in the alternative and in combination. As used herein, characters such as numerals refer to like elements.

According to some example embodiments, the systems and/or methods described herein may be under the control of one or more processors. The one or more processors may have access to computer-readable storage media (“CRSM”), which may be any available physical media accessible by the processor(s) to execute instruction stored on the CRSM. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other medium which can be used to store the desired information, and which can be accessed by the processor(s).

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

The following clauses form a part of the present disclosure.

Clause 1. A method for generating phase difference measurements between neighboring output beams, comprising:
projecting a plurality of output beams, each output beam emanating from an associated output beam source;
collimating or tailoring the divergence of the plurality of output beams by a plurality of lenses in a lens array;
forming a plurality of sampling regions on an output window or other appropriate surface;
directing, by the sampling regions, a sample of neighboring beam pairs back through the plurality of lenses; and
forming, at a detector, a focused pair of beams. In some cases, tailoring the plurality of output beams comprises collimating the plurality of output beams.

Clause 2. The method of clause 1, further comprising providing a pin or other appropriate aperture at a focus of the focused pair of beams. The aperture may be a pin aperture.

Clause 3. The method of clause 1, wherein an optical path from the sampling region to the aperture associated with the plurality of output beams have a same path length.

Clause 4. The method of clause 1, wherein there is a detector or an optical capture device at or after the aperture.

Clause 5. The method of clause 1, wherein the detector or optical capture device is a single mode waveguide.

Clause 6. The method of clause 1, wherein the detector or optical capture device is an optical fiber.

Clause 7. A method for measuring a phase difference between neighboring output beams, comprising:
measuring, with a detector or optical capture device, an optical sample;
demodulating a time series of subsequent optical samples to determine phase difference measurements;
unwrapping the phase difference measurements to generate a phase estimate;
adding the phase estimate to a beam steering or beam pattern phase offset to generate an error signal;
generating, by passing the error signal through an actuator filter and control block, phase command signals configured to modulate the phase of a beam sample at a channel control.

Clause 8. The method of clause 7, wherein the demodulating step comprises a timing control signal.

Clause 9. The method of clause 7, wherein the modulating and demodulating estimates a phase gradient by a two-point temporal modulation.

Clause 10. The method of any one of clauses 7-9, wherein the demodulating step comprises full circle reconstruction of the phase difference measurements.

Clause 11. The method of any one of clauses 7-10, further comprising adjusting the phase offset by a calibration error offset.

Clause 12. The method of any one of clauses 7-11, wherein the actuator filter and control block adds the phase command signals to a control output in accordance with timing signals.

Clause 13. The method of any one of clauses 7-12, wherein the actuator filter and control block comprise one or more of a pure integrator, a proportional-integral controller, a leaky integrator controller, and a proportional-integral-derivative controller.

Clause 14. The method of clause 7, further comprising combining the neighboring output beams into a spatially combined projected beam.

Clause 15. A gradient interferometrically locked laser source, comprising:
a laser source configured to produce an optical beam;
a beam splitter configured to split the optical beam into a plurality of output beams;
provisions to realize sampling region(s) wherein an optical path from focused beam pairs and/or the plurality of beams have the same path length
a detector configured to receive the plurality of output beams;
a demodulator configured to demodulate the plurality of output beams and further configured to determine phase difference measurements associated with the plurality of output beams;
a phase unwrapper configured to receive the phase difference measurements and determine, based at least in part on the phase difference measurements, a phase estimate;
an actuator filter and control block configured to receive the phase estimate and one or more of a beam steering offset, a beam pattern phase offset, and a calibration error offset and further configured to produce phase command signals to adjust one or more parameters of the plurality of output beams; and
a beam combiner configured to spatially combine the output beams in an array to form a projected laser beam.

Clause 16. The gradient interferometrically locked laser source of clause 25, further comprising a housing, and wherein the laser source, the beam splitter, the detector, the demodulator, the phase unwrapper, and the actuator filter and control block are located within the housing.

Clause 17. A spatial combiner for a coherent optical phased array laser, comprising:
a laser source configured to project a beam from the laser source;
one or more lenses spaced a first distance from the laser source;
an output window spaced a second distance from the one or more lenses;
a sampling region disposed on a first surface of the output window; and
a detector positioned adjacent the laser source;
wherein the spatial combiner is configured to:
   project a beam from the laser source in a first direction through a first space between the laser source and the one or more lenses; through the one or more lenses; through a second space between the one or more lenses and the sampling region; to the sampling region where two or more beams overlap;
   reflect the beams from the sampling region, through the second space, through the one or more lenses, through the first space, and to the detector positioned adjacent the laser source, with the path length of two or more beams being equal.

Clause 18. The spatial combiner as in clause 17, further comprising a housing, and wherein the one or more lenses, the output window, the sampling region, and the detector are located within the housing.

Clause 19. The spatial combiner as in clauses 17 or 18, wherein the sampling region is at least a partial reflector.

Clause 20. The spatial combiner as in any of clauses 17-19, wherein the sampling region defines a flat surface.

Clause 21. A method for generating measurement signals related to a plurality of phase differences between neighboring output beams, comprising: projecting a plurality of output beams, each output beam emanating from an associated output beam source; tailoring a collimation state of the plurality of output beams by a plurality of lenses in a lens array; forming a plurality of sampling regions on an output window; directing, by the sampling regions, a sample of neighboring beam pairs back through the plurality of lenses to form a focused pair of beams; and producing, by a detector, an optical sample signal associated with the focused pair of beams.

Clause 22. The method of clause 21, wherein an optical path length from the sampling regions to the detector is substantially the same between each pair of beams.

Clause 23. The method of clause 21 or 22, further comprising providing an aperture at a focus of the focused pair of beams to form a sample of the focused pair of beams.

Clause 24. The method of any one of clauses 21-23, wherein the detector is located after the aperture and measures the sample of the focused pair of beams.

Clause 25. The method of clause 21 wherein an optical capture device is located at the focus of the focused pair of beams and directs a sample of the focused pair of beams to the detector.

Clause 26. The method of clause 25, wherein the optical capture device is a single mode waveguide.

Clause 27. The method of clause 25, wherein the optical capture device is an optical fiber.

Clause 28. The method of clause 21, further comprising combining the neighboring beam pairs into a spatially combined projected beam.

Clause 29. The method of clause 21, wherein directing by the sampling regions further comprises directing a plurality of beam pairs and wherein each of the plurality of beam pairs is directed to one of a plurality of detectors.

Clause 30. A method for measuring phase values of a plurality of beams, comprising: measuring, with a detector, optical sample signals related to a phase difference between neighboring beams; demodulating a time series of subsequent optical sample signals to determine phase difference measurements; and unwrapping the phase difference measurements to generate a phase estimate.

Clause 31 The method of clause 30, wherein the demodulating step comprises a timing control signal.

Clause 32. The method of clause 31, wherein the modulating and demodulating estimates a phase gradient by a two-point temporal modulation.

Clause 33. The method of clause 32, wherein the demodulating step comprises full circle reconstruction of the phase difference measurements.

Clause 34. The method of any one of clauses 30-3, further comprising adjusting the phase estimate by a calibration error offset.

What is claimed is:

1. A method for coherently combining a plurality of beams, comprising:
projecting a plurality of output beams, each output beam emanating from an associated output beam source;
tailoring a collimation state of the plurality of output beams by a plurality of lenses in a lens array;
forming a plurality of sampling regions on an output window;
directing, by the sampling regions, a sample of neighboring beam pairs back through the plurality of lenses to form a focused pair of beams;
producing, by a detector, an optical sample signal of the focused pair of beams;
demodulating a time series of subsequent optical sample signals to determine phase difference measurements;
unwrapping the phase difference measurements to generate a phase estimate;
adding the phase estimate to a beam steering or beam pattern phase offset to generate an error signal; and
generating, by passing the error signal through an actuator filter and control block, phase command signals configured to modulate the phase of a beam sample at a channel control.

2. The method of claim 1, wherein an optical path length from the sampling regions to the detector is substantially the same between each pair of beams.

3. The method of claim 1, further comprising providing an aperture at a focus of the focused pair of beams to form a sample of the focused pair of beams.

4. The method of claim 3, wherein the detector is located after the aperture and further comprising measuring, by the detector, the sample of the focused pair of beams.

5. The method of claim 1, wherein an optical capture device is located at the focus of the focused pair of beams and further comprising directing, by the optical capture device, the sample of the focused pair of beams to the detector.

6. The method of claim 5, wherein the optical capture device is a single mode waveguide.

7. The method of claim 5, wherein the optical capture device is an optical fiber.

8. The method of claim 1, further comprising combining the plurality of output beams into a spatially combined projected beam.

9. The method of claim 1, wherein the actuator filter and control block adds the phase command signals to a control output in accordance with timing signals.

10. The method of claim 1, wherein the actuator filter and control block comprise one or more of a pure integrator, a proportional-integral controller, a leaky integrator controller, and a proportional-integral-derivative controller.

11. A method for generating measurement signals related to a plurality of phase differences between neighboring output beams of an optical beam generator, comprising:
projecting a plurality of output beams, each output beam emanating from an associated output beam source;
tailoring a collimation state of the plurality of output beams by a plurality of lenses in a lens array;
forming a plurality of sampling regions on an output window;
directing, by the sampling regions, the plurality of output beams to a detector producing an optical sample signal associated with the plurality of output beams.

12. The method of claim 11, wherein an optical path length from the sampling regions to the detector is substantially the same between each pair of beams.

13. A gradient interferometrically locked laser source, comprising:
a laser source configured to produce an optical beam;
a beam splitter configured to split the optical beam into a plurality of output beams;
a plurality of channel control devices configured to control a phase of the plurality of output beams and apply a modulation pattern to enable measurement of phase differences between the plurality of output beams;
a beam combiner configured with a plurality of lenses to spatially combine the plurality of output beams in an array to form a projected laser beam;
an output window having a plurality of sampling regions configured to direct samples of neighboring beam pairs back through the plurality of lenses to form a plurality of focused pairs of beams;
a plurality of detectors configured to produce a plurality of optical sample signals associated with the plurality of focused pairs of beams;
a demodulator configured to demodulate the plurality of output beams and further configured to determine phase difference measurements associated with the plurality of output beams;
a phase unwrapper configured to receive the phase difference measurements and determine, based at least in part on the phase difference measurements, a phase estimate; and
an actuator filter and control block configured to receive the phase estimate and one or more of a beam steering offset, a beam pattern phase offset, and a calibration error offset and further configured to produce phase command signals to adjust one or more parameters of the plurality of output beams.

14. The gradient interferometrically locked laser source of claim 13, wherein an optical path length extends from the plurality of sampling regions to the plurality of detectors, and wherein the optical path length is substantially the same for each of the plurality of focused pairs of beams.

15. The gradient interferometrically locked laser source of claim 13, further comprising a plurality of apertures, individual ones of the plurality of apertures located at a focus of each of the plurality of focused pairs of beams.

16. The gradient interferometrically locked laser source of claim 15, wherein the plurality of detectors is positioned downstream of the plurality of apertures.

17. The gradient interferometrically locked laser source of claim 13, further comprising a plurality of optical capture devices, wherein individual ones of the plurality of optical capture devices are configured to direct a sample of the focused pairs of beams to the plurality of detectors.

18. The gradient interferometrically locked laser source of claim 17, wherein the plurality of optical capture devices are single mode waveguides.

19. The gradient interferometrically locked laser source of claim 13, further comprising a housing, and wherein the beam splitter, the plurality of channel control devices, the beam combiner, the output window, and the plurality of detectors are located within the housing.
